(19) United States
(12) Patent Application Publication
(10) Pub. No.: US 2010/0260645 A1
(43) Pub. Date: Oct. 14, 2010

(54) ANTIMICROBIAL POROUS SUBSTRATE AND A METHOD OF MAKING AND USING THE SAME

(75) Inventor: Wah Boon Low, Singapore (SG)

Correspondence Address: MICHAUD-Kinney Group LLP, 306 INDUSTRIAL PARK ROAD, SUITE 206, MIDDLETOWN, CT, 06457, US

(73) Assignee: ANTIBAC LABORATORIES PTE LTD, (SG)

(21) Appl. No.: 12/744,559

(22) PCT Filed: Nov. 26, 2007
(86) PCT No.: PCT/SG2007/000407

§ 371 Date: May 25, 2010

(51) Int. Cl. A62B 7/00; B05D 1/36; B44C 1/22; B05D 3/10; B05D 3/00; B32B 3/10

(52) U.S. Cl. 422/122; 427/404; 216/83; 216/94; 427/299; 427/387; 428/305.5

(57) ABSTRACT

A method of preparing an antimicrobial air filter comprising the steps of: soaking a porous material in a silver nanoparticle colloid; and coating the porous material embedded with silver nanoparticles with a silane quaternary ammonium polymer such that the loss of silver nanoparticles is reduced. The resultant filter may be used in an air treatment device.

### FIELD OF THE INVENTION

The present invention relates to antimicrobial air filters, a method of making and using the same.

### BACKGROUND TO THE INVENTION

Human beings are often infected by microorganism like bacterium, mold, yeast, virus, and other infectious agents, in the living environment. Research as been intensive in the search for antibacterial material including various natural and inorganic substances such as tea extraction, chitosan, silver, copper, zinc, among many others. Silver is known to have antibacterial activity. Silver may be effective against over 650 strains of bacteria. The anti-bacterial activity of silver is dependent on the silver cation (Ag+), which binds strongly to electron donor groups on biological molecules containing sulfur, oxygen or nitrogen. The silver ions act by displacing other essential metal ions such as Ca2+ or Zn+. It is generally believed that heavy metals react with proteins, which leads to the inactivation of the proteins. It is generally believed that heavy metals react with proteins by combing the —SH groups of enzymes, which leads to the inactivation of the proteins.

The use of nanoparticles is currently under intensive investigation and there are several methods of coating and surface treatments have been suggested. Generally special techniques are needed to synthesize materials with particle size in the nanometer range. Also to obtain material containing nanoparticles demands unconventional methods since most of the formation techniques are energy intensive. A number of physical and chemical methods namely, vacuum deposition, molecular beam epitaxy, sputtering, laser assisted vacuum ablation, chemical vapour deposition have been used. These techniques need specialist equipment and are carried out at very high temperatures.

Several low temperature methods and processes have been developed to form material with nano-particles. Methods such as ion implantation, Ion Beam Assisted Deposition (IBAD) and Magnetron sputtering all require a very high initial capital investment, have high maintenance and operating costs and require very specialized operating skills. Simpler methods such as elecroless plating and padding or rolling have been introduced however these methods produce a lower rate of deposition, generate greater waste of nanoparticle sludge and have low adhesion of the nanoparticles which tend to drop off easily.

Spin coating has been used for several decades for the application of thin films and is now used for deposition of nanoparticles. Centripetal acceleration will cause the resin to spread to, and eventually off, the edge of the substrate leaving a thin film of resin on the surface. One of the difficulties with spin coating is repeatability. Subtle variations in the parameters that define the spin process can result in drastic variations in the coated film. Other difficulties that arise with spin coating include a lower rate of deposition, it generates greater waste of nanoparticles of up to 98%, the chemicals involved in the process are hazardous and there is low adhesion of the nanoparticles which tend to drop off easily.

In the last several years, a growing body of scientific evidence has indicated that the air within homes, offices, commercial buildings and cars can be more seriously polluted than the outdoor air in even the largest and most industrialized cities. Other research indicates that people spend approximately 90 percent of their time indoors. Thus, for many people, the risks to health may be greater due to exposure to air pollution indoors than outdoors.

Organofunctional silane technology has been used to treat surfaces such as clothing to give them antibacterial properties.

The present invention attempts to overcome at least in part some of the aforementioned disadvantages of previous methods.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention there is provided a method of preparing an antimicrobial substrate for use as a filter comprising the steps of: soaking a porous material in a silver nanoparticle colloid; and coating the porous material embedded with silver nanoparticles with a silane quaternary ammonium polymer such that the loss of silver nanoparticles is reduced.

Not wanting to be bound by any theory the binding of the particles to bacteria may depends on the surface area available for interaction. Smaller particles having a larger surface area available for interaction may be considered to have a stronger antimicrobial effect than the larger particles.

This new method may be achieved cost-effectively with a very low-cost initial capital investment and inexpensive maintenance and operating costs. Further the method is a very simple process that may be conducted at ambient conditions by people with relatively low level of technical skill. As pure silver-nano sol is used at ambient conditions without the use of any additional chemicals during the silver nanopatical embedding step it is possible to collect any unused silver-nano sol for re-use. This may reduce wastage of silver-nano sol. The process may provide good adhesion and uniformity of the silver-nanoparticles. The polymer coating may keep the silver nano particles in the initial deposition that may reduce leaching of the silver nanoparticles from the filter substrate. The process may further be very clean in that low waste sludge may be generated.

The method may further comprise the steps of etching the surface of the porous material with an agent such as hydrochloric acid or nitric acid or sulphuric acid or ozone or UV and or a pre-treatment step of washing the porous material with acetone or an alcohol and or drying the antimicrobial substrate.

In accordance with another aspect of the present invention there is provided an antimicrobial substrate for use as a filter comprising a porous material embedded with silver nanoparticles having a silane quaternary ammonium polymer coating.

In accordance with a further aspect of the present invention there is provided an air treatment device comprising an antimicrobial filter comprising a porous material embedded with silver nanoparticles having a silane quaternary ammonium polymer coating.

The device may further comprise deodorisers and or air fresheners or a fragrance cartridge

### BRIEF DESCRIPTION OF THE DRAWINGS

The present invention will now be described, by way of example, with reference to the accompanying drawings, in which:

FIG. 1 is a flow chart of a method of preparing an antimicrobial substrate for use as a filter in accordance with a first embodiment of the present invention.

FIG. 2 demonstrates the effect of an organofunctional silane covalent bonding on treated surface.

FIG. 3 demonstrates the polymer chemistry of the silane quaternary ammonium bonded to the surface of a porous material.

FIG. 4 demonstrates the effect a silane quaternary ammonium polymer permanently bonded to the surface even washed on the leaching test of silver nanoparticles.

FIG. 5 is a side view of an air treatment device incorporating an antimicrobial filter comprising a porous material embedded with silver nanoparticles having a silane quaternary ammonium polymer coating.

FIG. 6 is a plan view of an air treatment device incorporating an antimicrobial filter comprising a porous material embedded with silver nanoparticles having a silane quaternary ammonium polymer coating.

FIG. 7 is a cross sectional view of an air treatment device incorporating an antimicrobial filter comprising a porous material embedded with silver nanoparticles having a silane quaternary ammonium polymer coating.

### DESCRIPTION OF PREFERRED EMBODIMENTS

This invention discloses the use of nanosized silver particles for extra disinfection in air filtration. The silver nanoparticle has a diameter of 100 nm or less. In addition, nano sized silver are highly sensitive to oxygen, resulting in formation of partially oxidized silver with chemisorbed silver ion, which will have an additional contribution to the bactericidal properties of silver. Nano-sized silver could be used to safely and effectively inhibit the growth of bacteria, mould and fungi.

In accordance with the invention silver nanoparticle is coated on a relatively high surface area filter material (proprietary material made of either metal foam or polyurethane or polyester or non-woven paper). Materials made of either metal foam or polyurethane or polyester or non-woven paper which have a three-dimensional grid structure and show a high porosity and a high specific surface area, with considerable and uniform strength and tenacity are suitable to be used as the filter for silver nanoparticles coating.

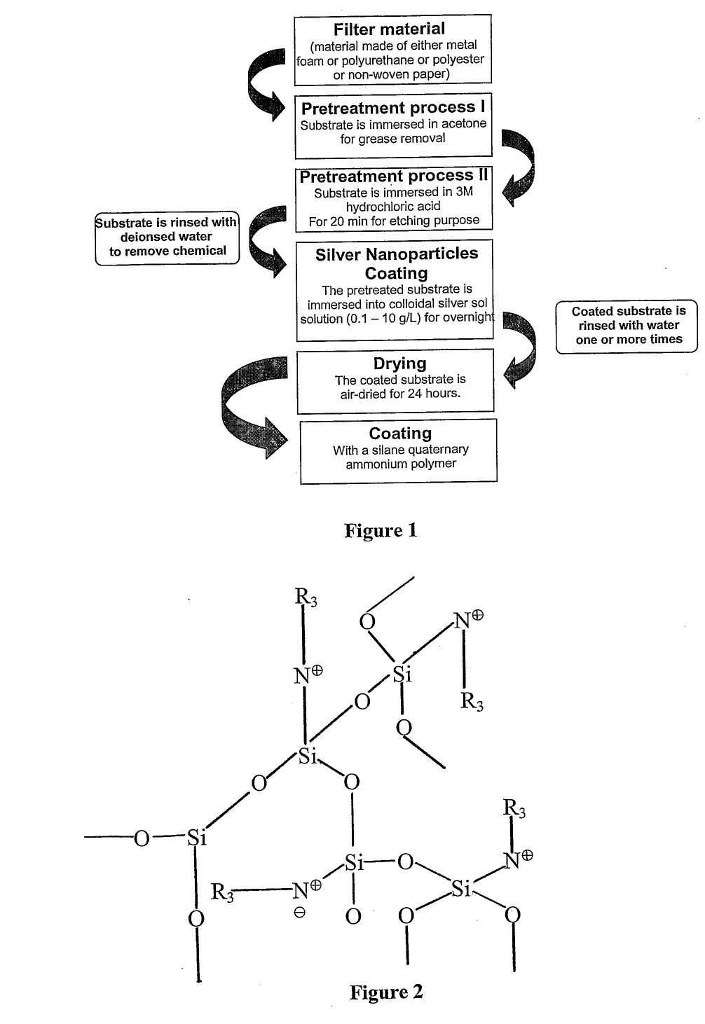

Referring to FIG. 1 the silver nanoparticle is coated on the filter substrate, illustratively nickel foam. A pretreatment process is first carried out using acetone and hydrochloric acid for surface cleaning and further etching of filter substrate. This is advantageous in forming an adherent silver coating onto the filter substrate. Nickel foam substrates are immersed in acetone to remove grease from the surfaces, and then dried in air. After this process, the nickel foam substrates are immersed in 3 M HCl at 25° C. for 20 min to remove any oxide layers and etch the nickel foam surface.

Hydrochloric acid is use to “etch” the filter substrate such as nickel foam to remove its oxide layers and/or any reactive chemicals on the nickel surface in order to prepare a “super-clean smooth layer” to allow silver nano to coat onto it easily. In addition, this process will also improve coating adhesion and uniformity to prevent “peeling effects” of nano-silver coated surface of the said substrate such as nickel foam.

After preparation, the nickel foam substrates are rinsed with deionised water to remove chemicals prior to further use. The pretreated substrate is then immersed into colloidal silver sol solution containing preferably from about 0.1 to about 10 g/liter of silver nanoparticles, and maintained at room temperature, preferably overnight. This leads to saturation coverage. Partial coverage can be achieved for shorter exposure times. The resulting coated nickel foam, is then rinsed with water one or more times, preferably with deionized water to remove any uncoated silver particles and is air-dried.

A silane quaternary ammonium compound such as 1,3, didecyl-2-methyl-imidazoline chloride, an active antimicrobial agent and dimethyl, methyl (polyethylene oxide) siloxane, a silane based, organosilane polymer that acts as an “adhesive to bond the active antimicrobial agent to the coated surface”. The antimicrobial polymer coating is then irremovable, and durable. The coating is applied on the surface of nickel foam embedded with silver nanoparticles by spraying applied in a single stage of the wet finish process, the attachment of this technology to surfaces involves two means. First and most important is a very rapid process, which coats the filter with the cationic species (physical-adsorption) one molecule deep. This is an ion exchange process by which the cation of the silane quaternary ammonium compound replaces protons from water or chemicals on the filter surface. The second mechanism is unique to materials such as silane quaternary ammonium compounds. In this case, the silanol allows for covalent bonding to receptive surfaces to occur (chemical-adsorption). This bonding to the substrate is then made even more durable by the silanol functionality, which enables them to homopolymerize. After they have coated the surface in this manner, they become virtually irremovable, even on surfaces with which they cannot react covalently (FIG. 2).

The addition of the silane quaternary ammonium polymer bonded on the surface of filter enhances the antibacterial function of the silver nanoparticles by reducing loss of the silver nanoparticles from leaching. The organofunctional silane from the silane quaternary ammonium polymer remains affixed to the substrate, killing microorganisms as they contact the surface to which it is applied, of which the technology actually polymerizes with the substrate making the surface antimicrobial. Once polymerized, the treatment does not migrate or create a zone of inhibition so it does not set up conditions that allow for adapted organisms. The resulting antimicrobial substrate embedded with silver nanoparticles having a silane quaternary ammonium polymer coating does not leach or diminish but instead remains permanently affixed to the applied surface over time. It does not poison the microorganism.

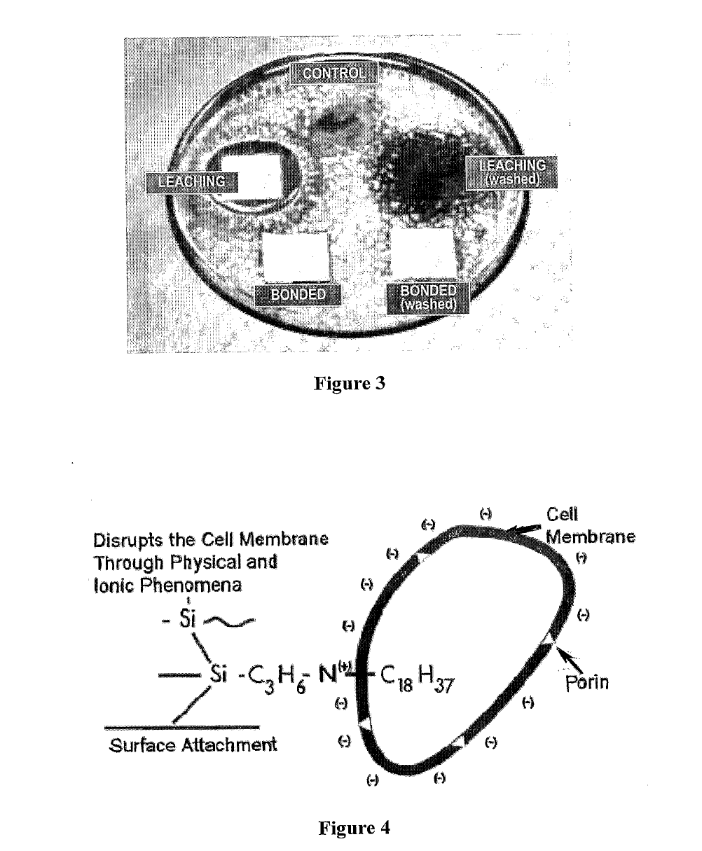

Referring to FIG. 3 it can be clearly seen that the silane quaternary ammonium polymer bonded to the substrate inhibits leaching of silver nanoparticles. The agar deposited with silver nanoparticles (10) leaches, The agar deposited with silver nanoparticles after several washes leached extensively (12), a porous material embedded with silver nanoparticals placed on agar (14) leached, a porous material embedded with silver nanoparticals coated with a silane quaternary ammonium plolymer placed on agar (16) showed minimal leaching, and a porous material embedded with silver nanoparticals coated with a silane quaternary ammonium plolymer placed on agar and washed several times (18) also demonstrated minimal leaching.

When a microbe (20) contacts the organofunctional silane treated surface of the filter (22), the cell is physically ruptured by a swordlike action and then electrocuted by a positively charged nitrogen molecule (FIG. 4).

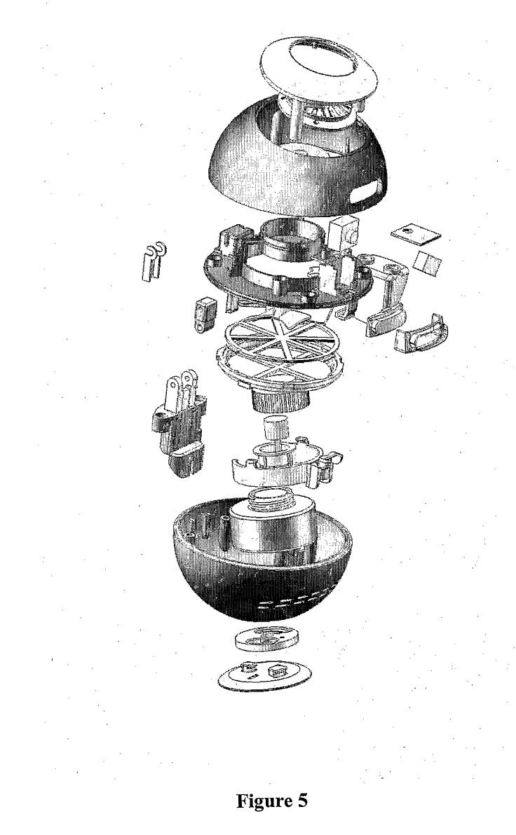

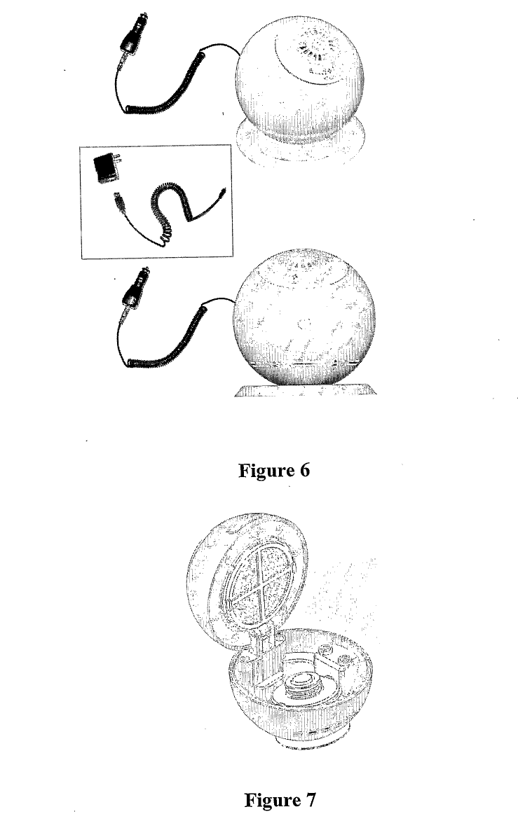

Referring to FIGS. 5, 6 and 7, the filter coated with “Nano-Silver together with silane quaternary ammonium polymer (24) is used as a preferred embodiment as a filter in an air treatment device. This unique antimicrobial surface-active filter destroys airborne germs, gram (+) bacteria, gram (−) bacteria, fungi, molds, mildew, yeast and algae on contact while excluding the filter itself as a future growth site for microbial contamination. The “Nano-Silver” coated filter with silane quaternary ammonium polymer permanent bonding process provides unequalled biological control without odors, migration or off-gassing and without creating organism mutation. Hence “Nano-Silver” coated filter treated with silane quaternary ammonium polymer bonded has an enhanced level of antimicrobial activity.

Deodorization (Odor Removal Means)

Most deodorizers on the market today use a cover up action to control odors. These “masking agents” are also called deodorizers, but masking agents contain heavy perfumes and only attempt to superimpose a pleasant odor upon an unpleasant one.

Through this embodiment, the silane quaternary ammonium polymer solution is a malodor-absorbing deodorizer containing active antimicrobial and deodorizer properties that removes the malodors by chemically reacting, counter-acting, neutralizing and dissolving the odors and toxic gases which are unpleasant to humans in an environmentally responsible and enhancing way rather than temporarily mask them. Silane quaternary ammonium polymer solution is non-toxic, non-corrosive and non-flammable. The compounds react to breakdown molecules so that odor is no longer present. The filter reacts automatically and simultaneously on a wide spectrum of gases from acidic (hydrogen sulfide, methyl mercaptan) to alkali odors (ammonia, trimethylamine) to abate the presence of odors and their gases counterparts.

A wide temperature range does not effect the combination of the silver nonoparticles and the silane quaternary ammonium polymer solution making it the ideal deodorizer for car environments that may experience high temperatures. During the evaporation time period, the effectiveness of deodorization does not change because the basic deodorizing agent does not evaporate.

In addition, the embodiment includes a semi-porous cellulose ester wick (26) to be placed into the silane quaternary ammonium polymer solution during the production. Both the semi-porous cellulose ester wick and the silane quaternary ammonium polymer solution formed a specific basis to control release/emission of aromatherapy fragrances as well as to prevent the re-emission of back-flows gases/chemicals, malodours and respirable suspended particles or fine particles. The semi-porous wick is not only used to control release of fragrances, but also to prolong the life-span of silane quaternary ammonium polymer solution up to 6 weeks as needed by this invention.

Air Freshener or Fragrance Cartridge

This embodiment also incorporates an interaction between the silane quaternary ammonium polymer solution and an air freshener (28). Essential Oils are used in the air freshener.

Preferably a high quality fragrance from a special blend of essential oils is used in the air freshener. The wick (26) allows the fragrance from the air freshener to maintain slow emission and control releases from the fan (30). The embodiment further incorporates both adsorption and scrubbing principal which are the two main process technology used for removing gases pollutants and malodors from indoor air.

Various embodiments and extra features are envisioned in relation to the present invention. Modifications and variations as would be apparent to a skilled addressee are deemed to be within the scope of the present invention.

1. A method of preparing an antimicrobial substrate for use as a filter, the method comprising the steps of:
soaking a porous material in a silver nanoparticle colloid; and
coating the porous material embedded with silver nanoparticles with a silane quaternary ammonium polymer comprising an organofunctional silane, wherein the organofunctional silane forms covalent bond with the porous material and homo-polymerizes to form the silane quaternary ammonium polymer coating to reduce the loss of silver nanoparticles.

2. The method of claim 1 further comprising the step of etching the surface of the porous material with an agent.

3. The method of claim 2 wherein the agent comprises hydrochloric acid or nitric acid or sulphuric acid or ozone or UV.

4. The method of claim 1 further comprising a pre-treatment step of washing the porous material with acetone or an alcohol.

5. The method of claim 1 further comprising the step of drying the antimicrobial substrate.

6. The method of claim 1 further comprising the step of placing a semi-porous wick in the silane quaternary ammonium polymer.

7. An antimicrobial substrate for use as a filter, the antimicrobial substrate comprising a porous material embedded with silver nanoparticles having a silane quaternary ammonium polymer coating wherein the silane quaternary ammonium polymer comprises an organofunctional silane, the organofunctional silane forming covalent bond with the porous material and homo-polymerizing to form the silane quaternary ammonium polymer coating to reduce the loss of silver nanoparticles.

8. The antimicrobial substrate of claim 7 wherein the porous material comprises metal foam or polyurethane or polyester or non-woven paper.

9. The antimicrobial substrate of claim 7 wherein the silane quaternary ammonium polymer coating comprises 1,3, didecyl-2-methyl-imidazoline chloride and dimethyl, methyl(polyethylene oxide)siloxane.

10. An air treatment device comprising an antimicrobial filter comprising a porous material embedded with silver nanoparticles having a silane quaternary ammonium polymer coating wherein the silane quaternary ammonium polymer comprises an organofunctional silane, the organofunctional silane forming covalent bond with the porous material and homo-polymerizing to form the silane quaternary ammonium polymer coating to reduce the loss of silver nanoparticles.

11. The air treatment device of claim 10 further comprising an odor removing means and or a freshener or fragrance cartridge.

12. The air treatment device of claim 11 wherein the freshener or fragrance cartridge is connected to the filter via a semi-porous wick
